(19) United States
(12) Patent Application Publication
(10) Pub. No.: US 2020/0271549 A1
(43) Pub. Date: Aug. 27, 2020

(54) METHOD OF AND APPARATUS FOR INSPECTING A FERROMAGNETIC OBJECT

(71) Applicant: KAL TIRE, Vernon (CA)

(72) Inventor: Dieter Wolfgang BLUM, Aldergrove (CA)

(73) Assignee: KAL TIRE, Vernon, BC (CA)

(21) Appl. No.: 16/646,395

(22) PCT Filed: Aug. 29, 2018
(86) PCT No.: PCT/CA2018/051042

§ 371 Date: Mar. 11, 2020

Related U.S. Application Data
(60) Provisional application No. 62/568,153, filed on Oct. 4, 2017.

(30) Foreign Application Priority Data
Sep. 12, 2017 (CA) 2,979,118

(51) Int. Cl. G01M 17/013; G01N 27/82; G01N 27/90

(52) U.S. Cl. CPC G01M 17/013; G01N 27/902; G01N 27/825

(57) ABSTRACT

A method of inspecting a ferromagnetic object includes positioning a plurality of magnetic field sensors proximate the ferromagnetic object and when a plurality of magnetic field sensors sense respective magnetic field values at respective different locations proximate at least one surface of the ferromagnetic object, causing the plurality of magnetic field sensors to generally traverse around the ferromagnetic object.

### FIELD

This disclosure relates generally to inspecting a ferromagnetic object.

### RELATED ART

Ferromagnetic objects, such as wheels for off-the-road (“OTR”) vehicles or other wheels for example, may be inspected, for example as part of a process to detect possible defects such as corrosion, wear, or other damage or imperfections that may arise over time. Non-destructive testing (“NDT”) techniques can be used to inspect ferromagnetic objects, but skilled NDT technicians can be costly and may not be available—often enough, or at all—at locations (such as remote mining sites, for example) where the inspection of ferromagnetic objects may be required. Therefore, sometimes wheels or other ferromagnetic objects must be transported long distances to locations where NDT is available. Further, some ferromagnetic objects, such as wheels for OTR vehicles for example, may be large, and NDT of such ferromagnetic objects may require time-consuming steps (such as washing and removing paint before inspection, and repainting after inspection), so NDT of some ferromagnetic objects can be time-consuming and costly.

Alternatively, wheels or other ferromagnetic objects may simply be discarded and replaced, for example after a threshold number of hours of use, which can be wasteful because objects may be discarded and replaced when the objects may still be in an acceptable condition or may be capable of being repaired.

### SUMMARY

In accordance with one illustrative embodiment of the invention, there is provided a method of inspecting a ferromagnetic object. The method may include: positioning a plurality of magnetic field sensors proximate the ferromagnetic object; and when a plurality of magnetic field sensors sense respective magnetic field values at respective different locations proximate at least one surface of the ferromagnetic object, causing the plurality of magnetic field sensors to generally traverse around the ferromagnetic object.

The method may further include causing the plurality of magnetic field sensors to generally traverse around the ferromagnetic object which may include causing a plurality of magnetic field sensor units, each comprising at least one of the plurality of magnetic field sensors, to rotate around the ferromagnetic object.

The plurality of magnetic field sensor units may be independently movable non-tangentially relative to the ferromagnetic object as the plurality of magnetic field sensors rotate around the ferromagnetic object.

The plurality of magnetic field sensor units may be independently movable generally radially relative to the ferromagnetic object as the plurality of magnetic field sensors rotate around the ferromagnetic object.

Each of the plurality of magnetic field sensor units may include two of the plurality of magnetic field sensors.

The plurality of magnetic field sensors may be generally coplanar.

The plurality of magnetic field sensors may be in respective different positions generally along an axial direction relative to the ferromagnetic object.

The plurality of magnetic field sensors may be in respective different positions generally along a generally vertical line.

The plurality of magnetic field sensors may be in respective different positions generally along a line with a linear density of about 200 of the plurality of magnetic field sensors per meter.

The plurality of magnetic field sensors may be in respective different positions generally along a line with a linear density of at least 200 of the plurality of magnetic field sensors per meter.

The plurality of magnetic field sensors may include a plurality of magnetic tunnel junction magnetic field sensors.

The plurality of magnetic field sensors may include a plurality of three-dimensional magnetic field sensors.

The method may include causing the plurality of magnetic field sensors to rotate around the ferromagnetic object which may include causing the plurality of magnetic field sensors to rotate around an axis of rotation of the ferromagnetic object.

The method may include causing the plurality of magnetic field sensors to rotate around the ferromagnetic object which may include causing the plurality of magnetic field sensors to rotate around an axis of symmetry of the ferromagnetic object.

The ferromagnetic object may be a wheel.

The ferromagnetic object may be a wheel of an off-the-road (“OTR”) vehicle.

In various embodiments, at least one surface of the ferromagnetic object may include at least one peripheral outer surface of the ferromagnetic object.

The method may further include causing at least one computer-readable medium to store representations of magnetic fields measured by the plurality of magnetic field sensors at a plurality of different rotational positions around the ferromagnetic object.

The method may further include causing the plurality of magnetic field sensors to rotate around the ferromagnetic object which may include causing at least one processor to control rotation of the plurality of magnetic field sensors around the ferromagnetic object.

The method may further include causing the plurality of magnetic field sensors to rotate around the ferromagnetic object which may include causing the plurality of magnetic field sensors to rotate around the ferromagnetic object and between about 0.5 millimeters and about 1 millimeter from the at least one surface of the ferromagnetic object.

The method may further include causing the plurality of magnetic field sensors to rotate around the ferromagnetic object which may include causing the plurality of magnetic field sensors to rotate around the ferromagnetic object and less than about 1 millimeter from the at least one surface of the ferromagnetic object.

In accordance with another illustrative embodiment of the invention, there is provided an apparatus for inspecting a ferromagnetic object. The apparatus may include: a measuring means for measuring a plurality of magnetic field values at respective different locations proximate at least one surface of the ferromagnetic object; and a rotating means for rotating the measuring means and the respective different sensing locations around the ferromagnetic object.

In accordance with another illustrative embodiment of the invention, there is provided an apparatus for inspecting a ferromagnetic object. The apparatus may include:
a rotatable support supportable on the ferromagnetic object and rotatable relative to the ferromagnetic object when supported on the ferromagnetic object; and
a plurality of magnetic field sensors supportable by the rotatable support;
wherein when the rotatable support is supported on the ferromagnetic object and when the plurality of magnetic field sensors are supported by the rotatable support:
the plurality of magnetic field sensors are positioned to measure respective magnetic field values at respective different locations proximate at least one surface of the ferromagnetic object; and
the plurality of magnetic field sensors and the respective different locations are rotatable around the ferromagnetic object in response to rotation of the rotatable support relative to the ferromagnetic object.

The apparatus may further include a plurality of magnetic field sensor units, each comprising at least one of the plurality of magnetic field sensors.

The plurality of magnetic field sensor units may be independently movable non-tangentially relative to the ferromagnetic object when the rotatable support is supported on the ferromagnetic object and when the plurality of magnetic field sensors are supported by the rotatable support.

The plurality of magnetic field sensor units may be independently movable generally radially relative to the ferromagnetic object when the rotatable support is supported on the ferromagnetic object and when the plurality of magnetic field sensors are supported by the rotatable support.

Each one of the plurality of magnetic field sensor units may include two of the plurality of magnetic field sensors.

The plurality of magnetic field sensors may be generally coplanar.

The plurality of magnetic field sensors may be in respective different positions generally along an axial direction relative to the ferromagnetic object.

The plurality of magnetic field sensors may be in respective different positions generally along a generally vertical line.

The plurality of magnetic field sensors may be in respective different positions generally along a line with a linear density of about 200 of the plurality of magnetic field sensors per meter.

The plurality of magnetic field sensors may be in respective different positions generally along a line with a linear density of at least 200 of the plurality of magnetic field sensors per meter.

The plurality of magnetic field sensors may include a plurality of magnetic tunnel junction magnetic field sensors.

The plurality of magnetic field sensors may include a plurality of three-dimensional magnetic field sensors.

When the rotatable support is supported on the ferromagnetic object and when the plurality of magnetic field sensors are supported by the rotatable support, the plurality of magnetic field sensors and the respective different locations may be rotatable around an axis of rotation of the ferromagnetic object in response to rotation of the rotatable support relative to the ferromagnetic object.

When the rotatable support is supported on the ferromagnetic object and when the plurality of magnetic field sensors are supported by the rotatable support, the plurality of magnetic field sensors and the respective different locations may be rotatable around an axis of symmetry of the ferromagnetic object in response to rotation of the rotatable support relative to the ferromagnetic object.

At least one surface of the ferromagnetic object may include at least one peripheral outer surface of the ferromagnetic object.

The apparatus may further include:
at least one processor in communication with the plurality of magnetic field sensors; and
at least one computer-readable medium in communication with the at least one processor and comprising codes stored thereon that, when executed by the at least one processor, cause the at least one processor to store, on the at least one computer-readable medium, respective representations of magnetic fields measured by the plurality of magnetic field sensors at different rotational positions of the plurality of magnetic field sensors relative to the ferromagnetic object.

The apparatus may further include at least one actuator that, when actuated, causes the rotatable support to rotate relative to the ferromagnetic object when the rotatable support is supported on the ferromagnetic object.

The apparatus may further include:
at least one processor in communication with the at least one actuator; and
at least one computer-readable medium in communication with the at least one processor and comprising codes stored thereon that, when executed by the at least one processor, cause the at least one processor to control the at least one actuator to control rotation of the rotatable support relative to the ferromagnetic object.

When the rotatable support is supported on the ferromagnetic object and when the plurality of magnetic field sensors are supported by the rotatable support, the plurality of magnetic field sensors may be positionable between about 0.5 millimeters and about 1 millimeter from the at least one surface of the ferromagnetic object.

When the rotatable support is supported on the ferromagnetic object and when the plurality of magnetic field sensors are supported by the rotatable support, the plurality of magnetic field sensors may be positionable less than about 1 millimeter from the at least one surface of the ferromagnetic object.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is an elevation view of an apparatus according to one embodiment for inspecting a wheel or one or more other ferromagnetic objects.

FIG. 2 is an elevation view of a rotatable support of the apparatus of FIG. 1 coupled to and supported by the wheel of FIG. 1.

FIG. 3 is an elevation view of a sensor support body of a sensor device of the apparatus of FIG. 1 coupled to and supported by the rotatable support FIG. 2.

FIG. 4 is a perspective view of the sensor device of the apparatus of FIG. 1.

FIG. 5 is a perspective view of a sensor module of the sensor device of FIG. 4.

FIG. 6 illustrates an example of measured values of magnetic field in three dimensions in a time series according to signals from a magnetic field sensor of the sensor device of FIG. 4 in ambient magnetic field of the Earth.

FIG. 7 illustrates an example of measured values of magnetic field in three dimensions in a time series according to signals from a magnetic field sensor of the sensor device of FIG. 4 near a magnet.

FIG. 8 is a perspective view of a sensor unit of the sensor module of FIG. 5.

FIG. 9 and FIG. 10 are schematic representations of the sensor device of FIG. 4.

FIG. 11A & FIG. 11B are a schematic representation of program codes that may be executed by a processor circuit of a control and processing device of the sensor device of FIG. 4.

FIG. 12 illustrates, according to one embodiment, vectors as calculated from magnetic field values measured at locations proximate a portion of a peripheral surface of a ferromagnetic wheel, illustrating both magnitude and direction of the vectors with the vectors projected on a plane.

FIG. 13 is a side view of the vectors of FIG. 12, illustrating both magnitude and direction of the vectors.

FIG. 14 is a perspective view of the vectors of FIG. 12, illustrating both magnitude and direction of the vectors.

FIG. 15 is a perspective view of the vectors of FIG. 12, illustrating only magnitude of the vectors.

FIG. 16 is a perspective view of the vectors of FIG. 12, illustrating both magnitude and direction of the vectors with the vectors projected on a cylinder.

FIG. 17 illustrates an example of an output report.

FIG. 18 provides further illustration of cluster finding described in the specification.

### DETAILED DESCRIPTION

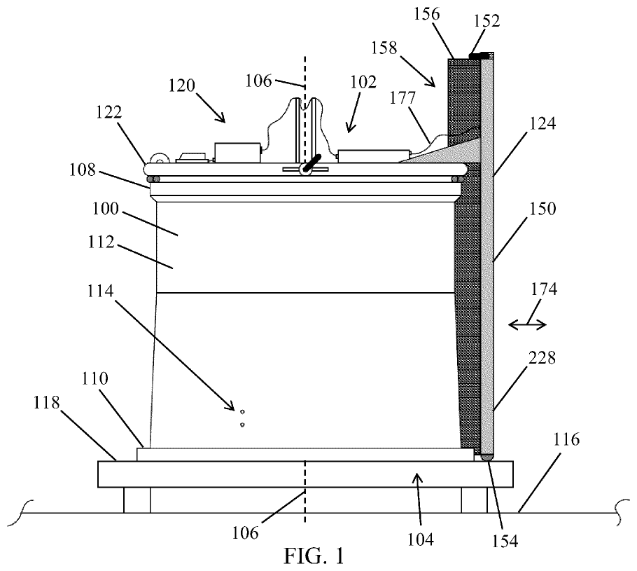

Referring to FIG. 1, in accordance with one embodiment, a wheel 100 is made of steel and is thus ferromagnetic. The wheel 100 is mountable to, and demountable from, a vehicle (for illustrative purposes only, an OTR vehicle). When the wheel 100 is mounted to an OTR vehicle, an inner side shown generally at 102 of the wheel 100 faces towards the OTR vehicle, an outer side shown generally at 104 of the wheel 100 is opposite the inner side 102 and faces away from the OTR vehicle, and the wheel 100 is rotatable around an axis of rotation 106. The wheel 100 includes an inner rim 108 situated generally on or proximate the inner side 102 and an outer rim 110 situated generally on or proximate the outer side 104. In various embodiments, the wheel 100 includes a peripheral outer surface 112 having a non-linear profile or a non-cylindrical shape, meaning that the peripheral outer surface 112 is not a consistent radial distance from the axis of rotation 106. The wheel 100 may also define at least one through-hole shown generally at 114 for receiving respective air valve stems for a tire mountable to the wheel 100. In various embodiments the wheel 100 may be generally axially symmetric around the axis of rotation 106, so the axis of rotation 106 is also generally an axis of symmetry.

In this context, “generally axially symmetric” refers to an object that may not be perfectly axially symmetric, but is sufficiently symmetric so as to function substantially similarly to an axially symmetric object.

Alternative embodiments may include one or more different wheels or different ferromagnetic objects which may be scanned or traversed, for instance which may be scanned or traversed in a generally radial or orbital orientation using one of the apparatuses or methods described herein. For example, alternative embodiments may include one or more wheels for vehicles other than OTR vehicles, or one or more ferromagnetic objects that are not necessarily wheels. Further, alternative embodiments may include one or more ferromagnetic objects that are not necessarily made of steel, and that may be made from one or more different ferromagnetic materials. Still further, ferromagnetic objects of alternative embodiments may have different shapes, and may for example be generally cylindrical or otherwise generally axially symmetric.

When the wheel 100, or one or more other ferromagnetic objects, are in a static external magnetic field, for example in an ambient magnetic field of the Earth, the wheel 100 (or one or more other ferromagnetic objects) may acquire an internal self-alignment of magnetic domains with such an external magnetic field and (in other words) may become magnetized. Such magnetization may cause magnetic fields near surfaces of the wheel 100 (or of one or more other ferromagnetic objects) that are stronger than the external magnetic field. Further, in some cases, such magnetization may become permanent or enduring over time. Therefore, some objects may require demagnetization, for example along a vertical axis to remove or diminish any permanent or enduring magnetization before inspection or other procedures. In some embodiments, for example, two steady magnetizations may be applied to one or more other ferromagnetic objects to minimize or to reduce background noise. However, during ordinary use or otherwise, the wheel 100 (or one or more other ferromagnetic objects) may frequently rotate and move, may therefore be frequently reoriented relative to the ambient magnetic field of the Earth, may therefore avoid acquiring permanent or enduring magnetization, and may therefore not require such demagnetization.

In FIG. 1 the wheel 100 is presented on its side for inspection. The wheel 100 may be lifted, for example by an operator using a tire manipulator, and supported (by a height of about 30 centimeters or about 12 inches, for example) above a ground surface or floor 116 by a support structure 118, with the outer side 104 facing the support structure 118 and with the axis of rotation 106 extending generally vertically, although the axis of rotation 106 is not necessarily vertical in alternative embodiments when the wheel 100 is positioned for inspection. The support structure 118 may be made of one or more non-ferromagnetic materials, such as aluminum, elastomers, fiberglass, polymers, or non-ferromagnetic stainless steel, for example. Further, the support structure 118 may be supported by elastomeric pads. Supporting the wheel 100 (or one or more other ferromagnetic objects) on the support structure 118 above the ground surface or floor 116 may reduce or avoid any magnetic effects from any steel or other ferromagnetic structures that may be in or below the ground surface or floor 116. However, alternative embodiments may include one or more different support structures, or may omit the support structure.

In some embodiments, the wheel 100 and the support structure 118 may be positioned at least about 20 feet or at least about 5 meters away from any large ferromagnetic objects such as any steel beams, girders, or walls, and kept at least about 20 feet or at least about 5 meters away from any large machinery such as forklifts or tire manipulators, for example. By reducing or avoiding any magnetic effects from any steel or other ferromagnetic structures as described above, for example, one may reduce or avoid the risk of magnetic effects from such ferromagnetic structures influencing the wheel 100 (or one or more other ferromagnetic objects). In various embodiments, the wheel 100 (or one or more other ferromagnetic objects) may be subjected only to the ambient magnetic field of the Earth, which may be from about 0.25 Gauss to about 0.65 Gauss, or about 0.5 Gauss, for example.

When the wheel 100 is supported as shown in FIG. 1, the wheel 100 may be magnetized by the ambient magnetic field of the Earth. When the wheel 100 (or one or more other ferromagnetic objects) is magnetized, variation of magnetic fields proximate the peripheral outer surface 112 may indicate one or more properties of the wheel 100, such as one or more defects (such as corrosion, wear, or other damage or imperfections that may arise over time) in wheel 100 and locations, types, characteristics, and/or severities of any such defects in wheel 100. For example, such variation of magnetic fields proximate the peripheral outer surface 112 may have magnitudes of about 10 nanoTesla to about 20 nanoTesla when caused by inhomogeneity, and such variation of magnetic fields proximate the peripheral outer surface 112 may have magnitudes of hundreds or thousands of nanoTesla when caused by flaws or by subsurface anomalies. Accordingly, a ferromagnetic object may be magnetized, for example in the ambient magnetic field of the Earth, and the ferromagnetic object may be inspected, for example by measuring magnetic field values at respective different locations proximate at least one surface of the ferromagnetic object as described below.

An apparatus according to one embodiment for inspecting at least one ferromagnetic object, such as the wheel 100 in the embodiment shown or one or more other ferromagnetic objects in other embodiments, is shown generally at 120 and includes a rotatable support 122 and a sensor device 124.

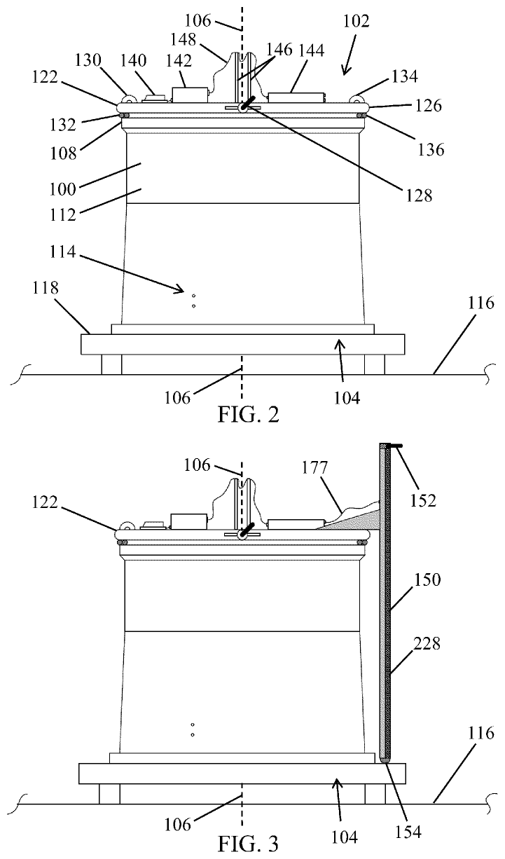

Referring to FIG. 2, the rotatable support 122 includes a rim-spanning structure 126 (or generally object-spanning or object-traversing structure for some other embodiments), which may include a cross-arm assembly sized to be coupled to and supported by the inner rim 108. The rim-spanning structure 126 includes an adjustment lever 128 that may allow adjustment of a length of the rim-spanning structure 126, which may permit the rim-spanning structure 126 to be supported on rims having different diameters. Further, the rim-spanning structure 126 includes a motor 130 operable to drive at least one drive wheel 132 positionable in physical and frictional contact with the inner rim 108, and the rim-spanning structure 126 also includes a motor 134 operable to drive at least one drive wheel 136 also positionable in physical and frictional contact with the inner rim 108. In some embodiments, the drive wheels 132 and 136 may be made from a material having a large coefficient of friction to reduce or avoid slipping on the inner rim 108, and the drive wheels 132 and 136 may also be made from a material that easily deforms to minor physical imperfections in the inner rim 108. The motors 130 and 134 and the drive wheels 132 and 136 are examples only, and more generally embodiments may include at least one actuator that, when actuated, may cause the rotatable support 122 to rotate relative to the wheel 100. In some embodiments, such rotation may be continuous, and may be generally around the axis of rotation 106.

Further, in some embodiments, an operator of the apparatus 120 may adjust a length of the rim-spanning structure 126 to approximately a diameter of the inner rim 108, for example within about 0.25 inches of the diameter of the inner rim 108, and then further adjust the length of the rim-spanning structure 126 until the at least one drive wheel 132 and the at least one drive wheel 136 physically and frictionally contact the inner rim 108. The rotatable support 122 is thus supportable on a ferromagnetic object (such as the wheel 100, for example) and rotatable relative to the ferromagnetic object when supported on the at least one ferromagnetic object.

When the motors 130 and 134 drive the drive wheels 132 and 136, the rim-spanning structure 126, and thus the rotatable support 122, rotate continuously relative to the wheel 100 generally around the axis of rotation 106. The rotatable support 122 is therefore continuously rotatable relative to the wheel 100 generally around the axis of rotation 106. In various embodiments the rotatable support 122 may be configured to rotate selectively under control of the operator.

The rotatable support 122 may also include at least one rechargeable battery 140, a power supply device 142, and a control and processing device 144. The at least one rechargeable battery 140 may be at least one standard (or commercial off-the-shelf) power-tool rechargeable battery, for example, and some embodiments may include two such batteries positionable in respective holders on the rim-spanning structure 126. Vertical stands 146 support a flexible cable 148 that electrically connects the power supply device 142 to the control and processing device 144, and such a flexible cable 148 may facilitate adjustment of the diameter of the rim-spanning structure 126 as described above, for example.

Alternative embodiments may include different rotatable supports, for example rotatable supports that may be adjustable in different ways, that are not necessarily adjustable, that may be supportable on one or more different ferromagnetic objects, that may be rotatable relative to one or more ferromagnetic objects in different ways, that may include one or more different sources of power or that may omit any sources of power, and that may include one or more different control and/or processing devices or that may omit any control and/or processing devices.

Referring to FIG. 1 and FIG. 3, the sensor device 124 includes a sensor support body 150 that may be coupled to and supported by the rotatable support 122. In some embodiments, weight of one or more of the rechargeable battery 140, the power supply device 142, the control and processing device 144, and an optional additional counterweight, for example, may offset weight of the sensor device 124 to prevent the rotatable support 122 from moving under the weight of the sensor device 124.

In the embodiment shown, the sensor support body 150 is rotatable about a generally vertical axis relative to the rotatable support 122 and includes a lever 152 that may lock the support body 150 into a rotational position relative to the rotatable support 122. The sensor support body 150 includes a roller 154 that movably supports the sensor support body 150 on the support structure 118. Therefore, rotation of the rotatable support 122 relative to the wheel 100 generally around the axis of rotation 106 may cause rotation of the sensor support body 150 relative to the wheel 100 generally around the axis of rotation 106, and more generally the sensor support body 150 is also continuously rotatable relative to the wheel 100 generally around the axis of rotation 106.

Alternative embodiments may include different sensor support bodies that may be supported in different ways, that may be movable in different ways, and that may be rotatable relative to one or more different ferromagnetic objects in different ways. For example, in some embodiments, the sensor support body 150 may be movable in other ways relative to the rotatable support 122, such as radially (relative to the wheel 100) towards and away from the wheel 100 for example, and the lever 152 may more generally lock the support body 150 into a position relative to the rotatable support 122. Also, in some embodiments, the lever 152 may be omitted or varied, and sensor support bodies of alternative embodiments may be coupled to and supported by rotatable supports (such as those described herein for example) in different ways, or sensor support bodies of alternative embodiments may be integrally formed with rotatable supports such as those described herein for example. Further, in some embodiments, the roller 154 may be omitted or varied, and sensor support bodies of alternative embodiments may be fully or partially supported by rotatable supports such as those described herein for example. In other embodiments, the sensor support body 150 may be rotatable about an axis of rotation relative to the rotatable support, wherein the axis of rotation is not vertical or generally vertical.

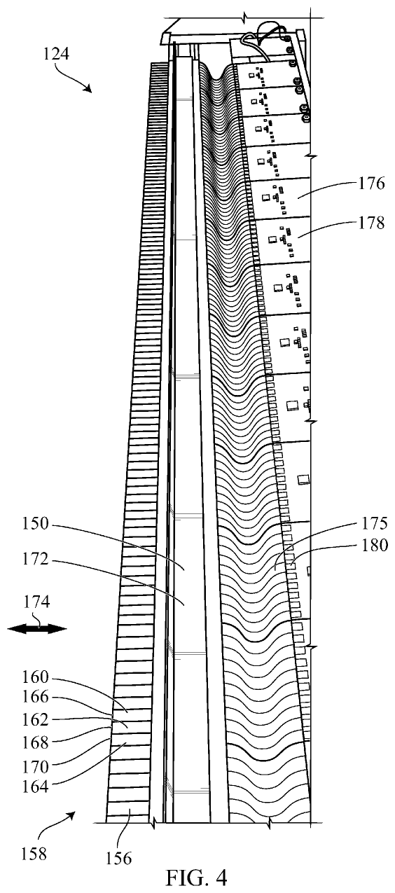

Referring to FIG. 1 and to FIG. 4, the sensor device 124 also includes a magnetic field sensor array 156 including magnetic field sensors (as described below, for example) of a plurality of sensor units shown generally at 158 and including, as examples only, a sensor unit 160, a sensor unit 162, and a sensor unit 164. The sensor units of the plurality of sensor units 158 have respective distal ends, and for example the sensor unit 160 has a distal end 166, the sensor unit 162 has a distal end 168, and the sensor unit 164 has a distal end 170.

As shown in FIG. 4, the sensor support body 150 includes a sensor unit guide body 172 that defines a plurality of channels, each sized to receive a respective one of the plurality of sensor units 158. The sensor support body 150 may permit the plurality of sensor units 158 to move, independently from each other, longitudinally in a transverse direction 174 relative to the sensor unit guide body 172, and thus relative to the sensor support body 150, and the sensor support body 150 may otherwise restrict or prevent movement of the plurality of sensor units 158 relative to the sensor support body 150. In various embodiments, the sensor support body 150 may permit the plurality of sensor units 158 to move longitudinally in the transverse direction 174 relative to the sensor support body 150 over a limited linear range of motion, such as a linear range of motion of about 5 centimeters, of about 6 centimeters, or of between about 3 inches and about 4 inches, for example. Further, the sensor units of the plurality of sensor units 158 may include respective resiliently deformable printed circuit board tapes, such as a resiliently deformable printed circuit board tape 175 of the sensor unit 164 for example, that may be resiliently compressed as shown in FIG. 4 and that may therefore resiliently urge the plurality of sensor units 158 longitudinally in the transverse direction 174 relative to the sensor support body 150 towards the distal ends of the sensor units of the plurality of sensor units 158. Alternative embodiments may omit such resiliently deformable printed circuit board tapes, may include one or more alternatives to such resiliently deformable tapes, and may urge the sensor units of the plurality of sensor units 158 in other ways.

When the rotatable support 122 is supported on at least one ferromagnetic object (such as the wheel 100, for example) as described above, for example, the sensor support body 150 may be coupled to and supported by the rotatable support 122 initially with the support body 150 in a rotational position relative to the rotatable support 122 that spaces the respective distal ends of the plurality of sensor units 158 apart from the peripheral outer surface 112. Then, as shown in FIG. 1, the sensor support body 150 may be rotated relative to the rotatable support 122 until the respective distal ends of the plurality of sensor units 158 physically contact the peripheral outer surface 112, and the lever 152 may be used to lock the support body 150 into such a position relative to the rotatable support 122. Also, the sensor device 124 may include a cord 177, which may be an electrical umbilical cord, which may transmit data between the sensor device 124 and the control and processing device 144, and which may be connected to the rotatable support 122 when the rotatable support 122 is supported on at least one ferromagnetic object (such as the wheel 100, for example) as described above and when the sensor support body 150 is coupled to and supported by the rotatable support 122.

As indicated above, the plurality of sensor units 158 may be coupled to and supported by the support body 150. When the plurality of sensor units 158 are coupled to and supported by the support body 150, and when the sensor support body 150 is coupled to and supported by the rotatable support 122, the plurality of sensor units 158 may thus be coupled to and supported by the rotatable support 122 and may be continuously rotatable relative to the wheel 100 generally around the axis of rotation 106, and the magnetic field sensors of the magnetic field sensor array 156 may rotate continuously relative to the wheel 100 generally around the axis of rotation 106 with their respective ones of the plurality of sensor units 158. In some embodiments, the rotatable support 122 may rotate the sensor device 124, the sensor support body 150, the plurality of sensor units 158, and the magnetic field sensors of the magnetic field sensor array 156 at a peripheral speed between about 3 millimeters per second and about 8 millimeters per second. In some embodiments, an operator of the of the apparatus 120 may control or configure rotational speed of the rotatable support 122 and peripheral speed of the sensor device 124, the sensor support body 150, the plurality of sensor units 158, and the magnetic field sensors of the magnetic field sensor array 156.

As shown in FIG. 4, in various embodiments the sensor support body 150 may support the plurality of sensor units 158 at locations generally along a (notional) line, which may be a straight or generally straight line, and as shown in FIG. 1, the sensor support body 150 may be positioned to support the plurality of sensor units 158 at locations generally along a vertical line (or in other embodiments along a notional, upwardly oriented line) and generally along a line (e.g. a generally straight line) parallel to the axis of rotation 106, so the plurality of sensor units 158 may have respective different locations generally along an axial direction relative to the wheel 100. The plurality of sensor units 158 may be spaced apart from each other along such a line, but may or may not be necessarily spaced apart from each other. Further, as shown in FIG. 1, the transverse direction 174 of movement of the plurality of sensor units 158 relative to the sensor support body 150 may be generally radial relative to the wheel 100, namely generally coplanar with and generally perpendicular to the axis of rotation 106. In some embodiments, the transverse direction 174 of movement of the plurality of sensor units 158 relative to the sensor support body 150 may be non-tangential relative to the wheel 100, namely non-perpendicular to a radius coplanar with and perpendicular to the axis of rotation 106.

Further, as the rotatable support 122, the support body 150, and the plurality of sensor units 158 rotate relative to the wheel 100 generally around the axis of rotation 106, the support body 150 may maintain the transverse direction 174 of movement of the plurality of sensor units 158 generally radial or non-tangential so that the plurality of sensor units 158 continue to be movable generally radially or non-tangentially relative to the wheel 100 as the rotatable support 122, the support body 150, and the plurality of sensor units 158 rotate relative to the wheel 100 generally around the axis of rotation 106.

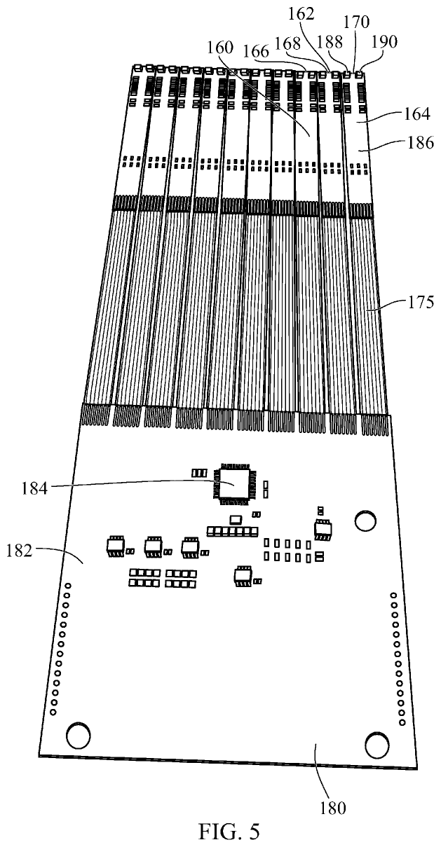

Referring to FIG. 4 and to FIG. 5, the sensor device 124 may include at least one sensor module, and each such at least one sensor module may include at least one of, or a plurality of, the plurality of sensor units 158. For example, as shown in FIG. 4 and in FIG. 5, the sensor device 124 includes a sensor module 176, a sensor module 178, and a sensor module 180, each including a respective different ten of the plurality of sensor units 158, and for example the sensor module 180 includes the sensor unit 160, the sensor unit 162, and the sensor unit 164. In alternative embodiments, the sensor array may differ and may include one or more different sensor modules, or may not include sensor modules. For example, in some embodiments, sensor modules may each include between two and 20 sensor units, or sensor modules may each include ten sensor units. The plurality of sensor units 158 may each include one or more of the magnetic field sensors of the magnetic field sensor array 156. Referring to FIG. 5, for illustrative purposes, in some embodiments the sensor module 180 may include a backplane printed circuit board 182 including a processor circuit including a microprocessor 184 in communication with ten of the plurality of sensor units 158 including the sensor unit 160, the sensor unit 162, and the sensor unit 164. The microprocessor 184 may be a microprocessor known as a DSPIC33EP256MU806 microprocessor and available from Microchip Technology Inc. of Chandler, Ariz., United States of America. Alternative embodiments may include alternatives to the microprocessor 184, such as other microprocessors, discrete logic circuits, and/or application-specific integrated circuits (“ASICs”), for example. The number of sensor units per sensor module may depend on a type of the microprocessor 184.

The sensor unit 164 includes a printed circuit board 186 including two magnetic field sensors 188 and 190 of the magnetic field sensor array 156, and the other ones of the plurality of sensor units 158 may include two respective different magnetic field sensors of the magnetic field sensor array 156. Some or all of the magnetic field sensors of the magnetic field sensor array 156 (such as the magnetic field sensors 188 and 190, for example) may be three-dimensional magnetic field sensors, and may be magnetic tunnel junction magnetic field sensors, such as magnetic tunnel junction magnetic field sensors known as MAG3110 magnetic field sensors and available from NXP Semiconductors N.V. of Eindhoven, Netherlands, for example. Alternative embodiments may include different magnetic field sensors, which are not necessarily three-dimensional magnetic field sensors and are not necessarily magnetic tunnel junction magnetic field sensors. In some embodiments, such magnetic field sensors may be no more than about 2 millimeters in width yet may have sensitivities to detect magnetic fields as small as about 15 nanoTesla, for example. Alternative embodiments may include one or more different types of magnetic field sensors, which may include Hall effect sensors, eddy current coils, or superconducting quantum interference device (“SQUID”) sensors, for example.

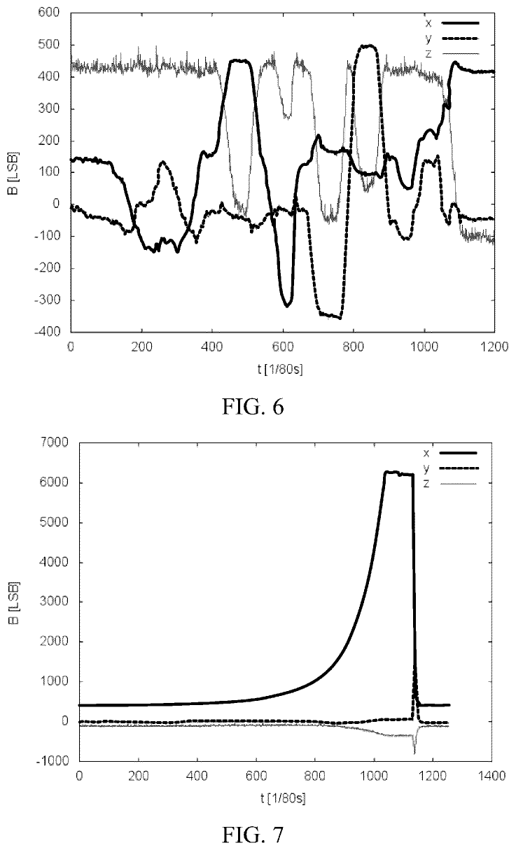

The magnetic field sensors of the magnetic field sensor array 156 may produce output signals indicating a time series of measured values of magnetic field in three dimensions. For example, FIG. 6 illustrates an example of measured values of magnetic field in three dimensions in a time series according to signals from a MAG3110 magnetic field sensor in ambient magnetic field of the Earth, and FIG. 7 illustrates an example of measured values of magnetic field in three dimensions in a time series according to signals from a MAG3110 magnetic field sensor near a magnet.

Such magnetic tunnel junction magnetic field sensors may include two layers of electrical conductors and a tunneling layer between the two layers of electrical conductors. One of the layers of electrical conductors may be permanently magnetized (or “pinned”) to about 2,000 Gauss, for example, and the other of the layers of electrical conductors may be not permanently magnetized (or “unpinned”) and thus subject to magnetization in response to external magnetic fields. However, sufficiently strong external magnetic fields (for example external magnetic fields of about 1.5 Tesla or above) may cause permanent or enduring magnetization of the ordinarily “unpinned” layer and may thus damage the magnetic tunnel junction magnetic field sensor. Therefore, maintaining external magnetic fields of the magnetic field sensor array 156 below about 1.5 Tesla may prevent damage to the magnetic field sensors of the magnetic field sensor array 156. However, permanent or enduring magnetization of the ordinarily “unpinned” layer may be reversed, and thus the ordinarily “unpinned” layer may be “unpinned” again, for example by an on-die current loop that may be triggered by a firmware command in some embodiments, or alternatively with application of a static magnetic field of a strength around 1.2 Tesla first in one direction and then in the reverse.

As indicated above and as shown in FIG. 1 and in FIG. 4, the sensor support body 150 may support the plurality of sensor units 158 at locations generally along a (notional) line, which may be a straight line, which may be a vertical line, and which may be in an axial direction relative to the wheel 100. Further, as shown in FIG. 5, the sensor units of the plurality of sensor units 158 may include more than one magnetic field sensor of the magnetic field sensor array 156, and magnetic field sensors of the magnetic field sensor array 156 on one of the plurality of sensor units 158 may also have locations on the one of the plurality of sensor units 158 along such a line. Therefore, the magnetic field sensors of the magnetic field sensor array 156 may also have locations generally along a line, which may be a straight line, which may be a vertical line, and which may be in an axial direction relative to the wheel 100. The magnetic field sensors of the magnetic field sensor array 156 may be spaced apart from each other along such a line, but are not necessarily spaced apart from each other.

Accordingly, the magnetic field sensors of the magnetic field sensor array 156 may be associated with respective different locations in at least one dimension in a co-ordinate system, which are respective different locations of the magnetic field sensors of the magnetic field sensor array 156 relative to the sensor device 124 or to the sensor support body 150. In the embodiment shown, the respective different locations of the magnetic field sensors of the magnetic field sensor array 156 relative to the sensor device 124 or to the sensor support body 150 are associated with respective different locations in an axial dimension direction relative to the wheel 100, but may be associated with respective different locations in one or more other dimensions in alternative embodiments.

Further, as indicated above, the sensor support body 150 may permit the plurality of sensor units 158 to move, independently from each other, longitudinally in the transverse direction 174 relative to the sensor support body 150, and the magnetic field sensors of the magnetic field sensor array 156 may therefore move with their respective ones of the plurality of sensor units 158 in the transverse direction 174 relative to the sensor support body 150. Nevertheless, the magnetic field sensors of the magnetic field sensor array 156 may remain generally in a common plane as the magnetic field sensors of the magnetic field sensor array 156 move in the transverse direction 174 relative to the sensor support body 150, so the magnetic field sensors of the magnetic field sensor array 156 may be generally coplanar.

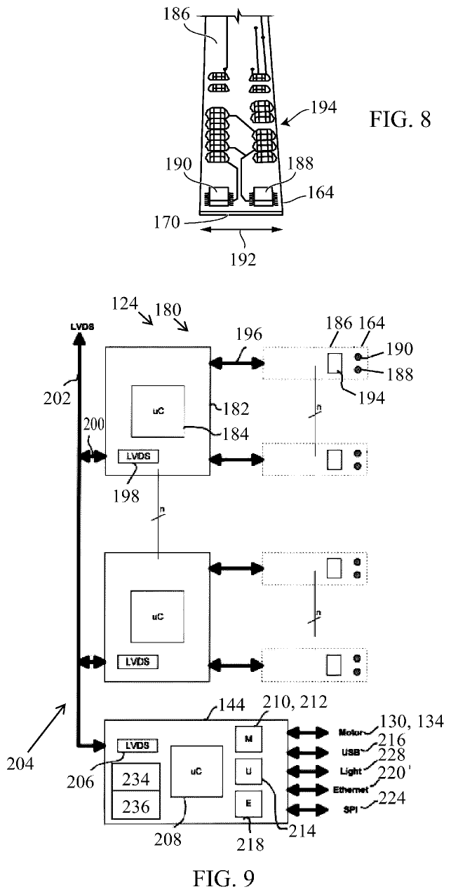

As shown in FIG. 8, in some embodiments the sensor unit 164 has a transverse width 192 of less than 1 centimeter, or of about 1 centimeter, so that when the sensor support body 150 supports the plurality of sensor units 158 at locations generally along a straight line as shown in FIG. 4, the plurality of sensor units 158 may have a linear density of about 100 of the sensor units per meter or of at least 100 of the sensor units per meter. Further, when each of the plurality of sensor units 158 includes two respective different magnetic field sensors such as the magnetic field sensors 188 and 190 of the sensor unit 164, the magnetic field sensors of the magnetic field sensor array 156 may have a linear density of about 200 of the magnetic field sensors per meter or of at least 200 of the magnetic field sensors per meter. However, in alternative embodiments, the sensor units may differ and may, for example, have different sizes and may include one or more than two respective different magnetic field sensors. For example, some embodiments may include between about 100 of the magnetic field sensors per meter and about 2,000 of the magnetic field sensors per meter.

As indicated above and as shown in FIG. 1, the sensor support body 150 may be moved relative to the rotatable support 122 until the respective distal ends of the plurality of sensor units 158 physically contact the peripheral outer surface 112, and the lever 152 may be used to lock the support body 150 into such a position relative to the rotatable support 122. As indicated above, the plurality of sensor units 158 may be resiliently urged longitudinally in the transverse direction 174 relative to the sensor support body 150 towards the distal ends of the sensor units of the plurality of sensor units 158 to maintain the distal ends of the sensor units of the plurality of sensor units 158 in contact with the peripheral outer surface 112, and movement of the plurality of sensor units 158 in the transverse direction 174 relative to the sensor support body 150 may accommodate the non-cylindrical shape of the peripheral outer surface 112, and more generally may allow the respective distal ends of the plurality of sensor units 158 to conform to and contact surfaces of one or more different ferromagnetic objects.

The magnetic field sensors of the magnetic field sensor array 156 may be positioned proximate the respective distal ends of the plurality of sensor units 158 so that, when the sensor support body 150 is moved generally radially relative to the rotatable support 122 to position the respective distal ends of the plurality of sensor units 158 in physical contact the peripheral outer surface 112, the magnetic field sensors of the magnetic field sensor array 156 (such as the magnetic field sensors 186 and 188, for example) may be proximate the peripheral outer surface 112 and may thus be positioned to measure respective magnetic field values at respective different locations proximate the peripheral outer surface 112. For example, in some embodiments, the magnetic field sensors of the magnetic field sensor array 156 may be positionable about 0.1 millimeter, or between about 0.5 millimeters and about 1 millimeter, or less than about 1 millimeter, from the peripheral outer surface 112. In alternative embodiments, the magnetic field sensors of the magnetic field sensor array 156 may be positioned to measure respective magnetic field values at respective different locations proximate at least one surface of at least one ferromagnetic object in other ways.

Referring to FIG. 8 and to FIG. 9, each sensor unit may include conditioning circuitry in communication with the respective at least one sensor of the sensor unit. For example, the printed circuit board 186 includes conditioning circuitry 194 in communication with the magnetic field sensors 188 and 190. Output signals from magnetic tunnel junction magnetic field sensors, such as signals from MAG3110 magnetic field sensors for example, may include random error signals, which may be filtered out by conditioning circuitry 194, for example.

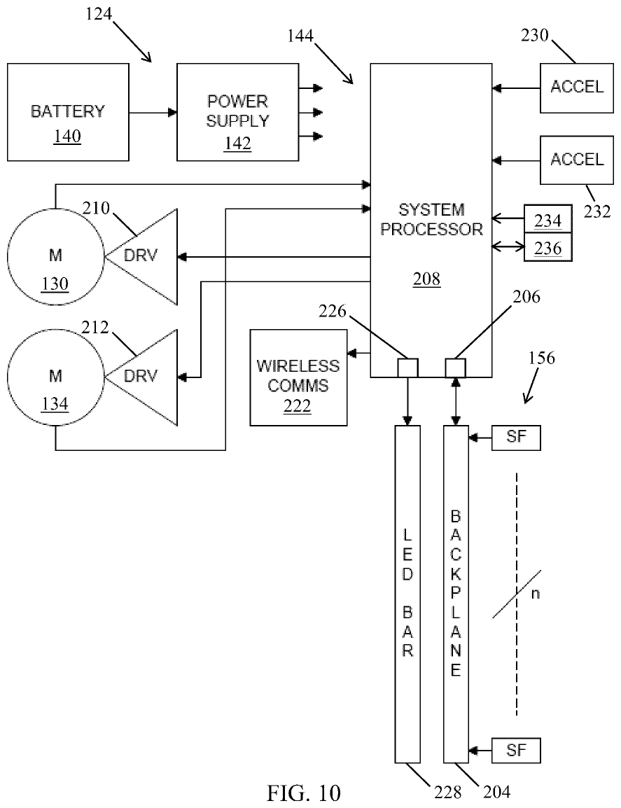

FIG. 9 and FIG. 10 illustrate the control and processing device 144 (also shown in FIG. 2) according to some embodiments, although FIG. 9 and FIG. 10 are examples only, and the control and processing device 144 may differ in alternative embodiments.

Referring to FIG. 9, an inter-integrated circuit (“I²C”) 196 may connect the printed circuit board 186 to the backplane printed circuit board 182, and the sensor module 180 may include any number of sensor units, which may be substantially the same as the sensor unit 164, and which may have respective I²Cs connecting respective printed circuit boards to the backplane printed circuit board 182 as shown in FIG. 9. Alternative embodiments may include alternatives to I²Cs. The backplane printed circuit board 182 also includes a low-voltage differential signaling (“LVDS”) interface 198 connecting the sensor module 180 over a connection 200 with an LVDS communication bus 202.

A backplane shown generally at 204 of the sensor device 124 may include backplane printed circuit boards of the sensor modules (such as the backplane printed circuit board 182 of the sensor module 180) and/or the LVDS communication bus 202. The sensor device 124 may include any number of sensor modules, such as 15 to 25 sensor modules for example, which may be substantially the same as the sensor module 180, and which may have respective LVDS interfaces connecting (for example, by daisy chaining) the sensor modules to the LVDS communication bus 202 as shown in FIG. 9. Alternative embodiments may include alternatives to LVDS interfaces.

Referring to FIG. 9 and to FIG. 10, the control and processing device 144 (also shown in FIG. 2) includes an LVDS interface 206 in communication with the LVDS communication bus 202. The LVDS communication bus 202 may permit two-way communication between sensor modules, such as 15 to 25 sensor modules for example, and the control and processing device 144. Again, alternative embodiments may include alternatives to LVDS interfaces. The control and processing device 144 also includes a processor circuit including a microprocessor 208 in communication with the LVDS interface 206. The microprocessor 208 may also be a microprocessor known as a DSPIC33EP256MU806 microprocessor from Microchip Technology Inc., but again alternative embodiments may include alternatives to the microprocessor 208, such as other microprocessors, discrete logic circuits, and/or ASICs, for example.

The control and processing device 144 also includes a motor driver 210 in communication with the microprocessor 208 and with the motor 130 (also shown in FIG. 2) to drive the motor 130 and thus the at least one drive wheel 132 (shown in FIG. 2) in response to signals from the microprocessor 208. The control and processing device 144 also includes a motor driver 212 in communication with the microprocessor 208 and with the motor 134 (also shown in FIG. 2) to drive the motor 134 and thus the at least one drive wheel 136 (shown in FIG. 2) in response to signals from the microprocessor 208.

The control and processing device 144 may also include one or more different communication interfaces that may differ in different embodiments. For example, the control and processing device 144 may include a universal serial bus (“USB”) interface 214 in communication with the microprocessor 208 and in communication with a USB port 216 to transmit and receive USB signals at the USB port 216, and the control and processing device 144 may also include an Ethernet interface 218 in communication with the microprocessor 208 and in communication with an Ethernet port 220 to transmit and receive Ethernet signals at the Ethernet port 220. The control and processing device 144 may also include a wireless communications interface 222 in communication with the microprocessor 208 to transmit and receive wireless communications signals at the wireless communications interface 222. The control and processing device 144 may also include a serial peripheral interface (“SPI”) bus interface 224 in communication with the microprocessor 208 to transmit and receive SPI signals at the SPI bus interface 224. In different embodiments, the control and processing device 144 may include one or more communication interfaces, which may include or may differ from the examples shown in FIG. 9 and in FIG. 10, or some embodiments may omit such communication interfaces.

The control and processing device 144 may also include a visual indicator control interface 226 in communication with an indicator device 228, which may for example include an array of lights (such as an array of light-emitting diodes (“LEDs”), for example) or another visual indicator extending along the support body 150 (as shown in FIG. 1 or in FIG. 3, for example) and operable to indicate one or more locations along the support body 150 in response to signals from the microprocessor 208, and thus operable to indicate one or more locations on the peripheral outer surface 112 proximate the support body 150 in response to signals from the microprocessor 208. For example, by causing one or more lights on the indicator device 228 to illuminate, the microprocessor 208 can cause the indicator device 228 to indicate one or more locations on the peripheral outer surface 112 proximate the support body 150. The indicator device 228 may have a linear density of lights, and thus a linear resolution, that may be about the same as linear density of the magnetic field sensors of the magnetic field sensor array 156, which (as indicated above) may be about 200 of the magnetic field sensors per meter or of at least 200 of the magnetic field sensors per meter. The indicator device 228 may also be operable to indicate other information, such as a status of the apparatus 120 or of inspection by the apparatus 120 or a type of defect, for example.

The sensor device 124 may include one or more accelerometers, such as accelerometers 230 and 232 on the support body 150 for example, that may produce signals representing measured acceleration at the one or more accelerometers. The control and processing device 144 may also receive signals from such accelerometers 230 and 232. Alternative embodiments may include more or fewer accelerometers, or may omit accelerometers.

In some embodiments, the motors 130 and 134 may transmit signals to the microprocessor 208 to indicate rotational movement and thus rotational positions of the sensor device 124, the sensor support body 150, and the magnetic field sensors of the magnetic field sensor array 156. In other embodiments, the accelerometers 230 and 232 may transmit signals to the microprocessor 208 to indicate rotational movement and thus rotational positions of the sensor device 124, the sensor support body 150, and the magnetic field sensors of the magnetic field sensor array 156. In other embodiments, one or more shaft encoders may transmit signals to the microprocessor 208 to indicate rotational movement and thus rotational positions of the sensor device 124, the sensor support body 150, and the magnetic field sensors of the magnetic field sensor array 156. In other embodiments, one or more devices, which may include one or more motors, one or more accelerometers, one or more shaft encoders, or a combination of one or more thereof, may transmit signals to the microprocessor 208 to indicate rotational movement and thus rotational positions of the sensor device 124, the sensor support body 150, and the magnetic field sensors of the magnetic field sensor array 156.

The control and processing device 144 may also include program memory 234 that may store blocks of code for directing the microprocessor 208 to implement methods such as those described herein, and the control and processing device 144 may also include storage memory 236 that may store measurement data and other data as described herein, for example. The program memory 234 and the storage memory 236 may be implemented in one or more computer-readable storage media, which may be the same or different computer-readable storage media, and which may include one or more of a read-only memory (“ROM”), random access memory (“RAM”), a hard disc drive (“HDD”), and other computer-readable and/or computer-writable storage media.

To inspect the wheel 100, the wheel 100 may be supported on the support structure 118 as shown in FIG. 1 with the outer rim 110 facing support structure 118. The rim-spanning structure 126 may be coupled to and supported by the inner rim 108 with the sensor support body 150 and thus the sensor device 124 coupled to and supported by the rotatable support 122 as shown in FIG. 1 and in FIG. 2. Then the sensor support body 150 may be moved relative to the rotatable support 122 until the respective distal ends of the plurality of sensor units 158 physically contact the peripheral outer surface 112 with the sensor support body 150 radially spaced apart from the peripheral outer surface 112, and the lever 152 may be used to lock the support body 150 into such a position relative to the rotatable support 122. Then the apparatus 120 may inspect the wheel 100, for example as described below. The wheel 100 is an example only, more generally and the apparatus 120 may inspect at least one ferromagnetic object according to similar methods.

In general, one or more ferromagnetic objects may be inspected by causing magnetic field sensors such as the magnetic field sensors of the magnetic field sensor array 156 to measure respective magnetic field values at respective different locations proximate at least one surface of the at least one ferromagnetic object at different ones of a plurality of rotational positions relative to the at least one ferromagnetic object. In some embodiments, a method of use of the apparatus 120 may initially involve causing the apparatus 120 to rotate at least once relative to the wheel 100 (or to one or more other ferromagnetic objects), which may take less than about one minute, to check for any misalignment of the apparatus 120 and to check for any rotational asymmetry in the inner rim 108 or in any other structure that the rotatable support 122 may interact with to cause rotation of the apparatus 120 relative to one or more other ferromagnetic objects. In some embodiments, the rotatable support 122 may automatically detect such rotational asymmetry, for example by detecting tension variations.

As indicated above, the magnetic field sensors of the magnetic field sensor array 156 (such as the magnetic field sensors 186 and 188, for example) may be proximate the peripheral outer surface 112 and may thus be positioned to measure respective magnetic field values at respective different locations proximate the peripheral outer surface 112, and the magnetic field sensors of the magnetic field sensor array 156 may be associated with respective different locations relative to the sensor device 124 or to the sensor support body 150 in at least one dimension in a co-ordinate system, which are respective different locations in an axial dimension relative to the wheel 100 in the embodiment shown, but which may be respective different locations in one or more other dimensions in alternative embodiments.

Further, as indicated above, the sensor device 124, the sensor support body 150, and the magnetic field sensors of the magnetic field sensor array 156 may rotate relative to the wheel 100 generally around the axis of rotation 106 with their respective ones of the plurality of sensor units 158, and different rotational positions of the sensor device 124, the sensor support body 150, and the magnetic field sensors of the magnetic field sensor array 156 may also be associated with respective different locations in at least one dimension in a co-ordinate system relative to the wheel 100. In the embodiment shown, the different rotational positions of the sensor device 124, the sensor support body 150, and the magnetic field sensors of the magnetic field sensor array 156 relative to the wheel 100 are respective different locations in a peripheral or azimuthal direction relative to the wheel 100, but may be respective different locations in one or more other dimensions in alternative embodiments.

Therefore, by positioning the magnetic field sensor array 156 at different rotational positions relative to at least one ferromagnetic object, and by causing the magnetic field sensors of the magnetic field sensor array 156 to measure, at such different rotational positions, respective magnetic field values at respective different locations proximate at least one surface of the at least one ferromagnetic object, magnetic field values may be measured at different locations in at least two different dimensions in a co-ordinate system, namely the at least one dimension associated with different locations of the magnetic field sensors of the magnetic field sensor array 156 relative to the sensor device 124 or to the sensor support body 150, and the at least one dimension associated with the different rotational positions of the sensor device 124, the sensor support body 150, and the magnetic field sensors of the magnetic field sensor array 156 relative to the at least one ferromagnetic object.

Such different locations in at least two different dimensions in a co-ordinate system may be defined relative to an index location on the at least one ferromagnetic object. In general, ferromagnetic objects may include features that may be used for indexing, for example that allow the apparatus 120 to identify a reference point for inspection. On the wheel 100, for example, the sensor device 124 may be able to sense magnetic field values surrounding the at least one through-hole 114, and the apparatus 120 may therefore be able to identify locations in at least two different dimensions in a co-ordinate system relative to the at least one through-hole 114. In other embodiments, one or more index locations may be indicated in other ways, and may for example be indicated by one or more permanent magnets that the apparatus 120 may be able to identify. More generally, the apparatus 120 may therefore be able to identify locations in at least two different dimensions in a co-ordinate system relative to at least one index location.

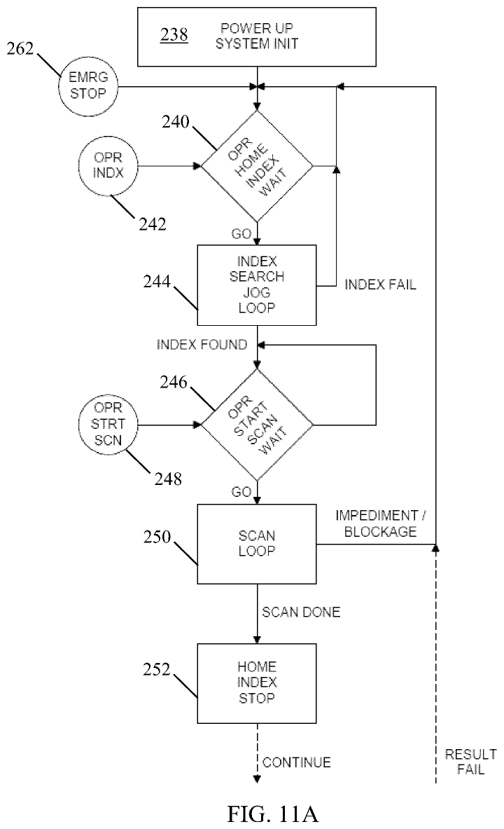

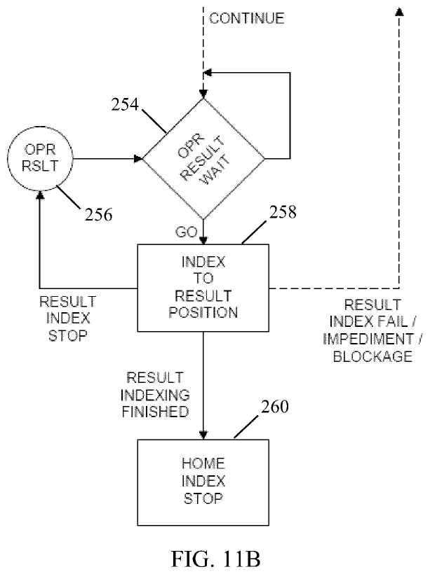

Referring to FIG. 11A and to FIG. 11B, blocks of program codes in the program memory 234 are illustrated schematically and may begin at block 238, which may include codes for directing the microprocessor 208 to initialize the apparatus 120. The program codes in the program memory 234 may then continue at block 240, which may include codes for directing the microprocessor 208 to receive an indexing initiation input signal 242 from an operator initiating indexing of the apparatus 120. For example, the operator may use a mobile phone, a tablet computer, a personal computer, or another input device to produce the indexing initiation input signal 242 and to transmit the indexing initiation input signal 242 to the control and processing device 144 (for example to one or more communication interfaces such as the USB interface 214, the Ethernet interface 218, the wireless communications interface 222, or the SPI bus interface 224). The microprocessor 208 may repeatedly execute the codes at block 240 until the indexing initiation input signal 242 is received. Before produce the indexing initiation input signal 242, the operator may manually move the rotatable support 122 and the sensor device 124 so that the sensor device 124 is near an index location in order to reduce time that may be required for the apparatus 120 to find the index location.

After the indexing initiation input signal 242 is received, the program codes in the program memory 234 may then continue at block 244, which may include codes for directing the microprocessor 208 to cause the apparatus 120 to find an index location on the wheel 100 (or on one or more other ferromagnetic objects). For example, in the embodiment shown, the codes at block 244 may direct the microprocessor 208 to cause the motor drivers 210 and 212 to control the motors 130 and 134 to cause the rotatable support 122 to rotate to different rotational positions relative to the wheel 100 generally around the axis of rotation 106, and to cause the magnetic field sensors of the magnetic field sensor array 156 to sense magnetic fields in such different rotational positions, until the magnetic field sensors of the magnetic field sensor array 156 sense magnetic fields consistent with the at least one through-hole 114 (or at least one index location on one or more other ferromagnetic objects). The codes at block 244 may direct the microprocessor 208 to identify rotational positions of the sensor device 124, the sensor support body 150, and the magnetic field sensors of the magnetic field sensor array 156, for example from one or more signals that may be received one or more devices, which may include one or more of the motors 130 and 134, one or more of the accelerometers 230 and 232, or one or more other devices.

If such an index location is not located at block 244, then the program codes in the program memory 234 may return to block 240. However, if such an index location is located at block 244, then the program codes in the program memory 234 may continue at block 246, which may include codes for directing the microprocessor 208 to receive a scan initiation input signal 248 from the operator initiating indexing of the apparatus 120. For example, the operator may use a mobile phone, a tablet computer, a personal computer, or another input device to produce the scan initiation input signal 248 and to transmit the scan initiation input signal 248 to the control and processing device 144 (for example to one or more communication interfaces such as the USB interface 214, the Ethernet interface 218, the wireless communications interface 222, or the SPI bus interface 224). The microprocessor 208 may repeatedly execute the codes at block 246 until the scan initiation input signal 248 is received.

After the scan initiation input signal 248 is received, the program codes in the program memory 234 may then continue at block 250, which may include codes for directing the microprocessor 208 to cause the motor drivers 210 and 212 to control the motors 130 and 134 to cause the rotatable support 122 to rotate in different rotational positions and to cause the magnetic field sensors of the magnetic field sensor array 156 to measure, at each of such different rotational positions, respective magnetic field values at respective different locations proximate the peripheral outer surface 112 (or proximate at least one surface of at least one ferromagnetic object). Such different rotational positions may begin before, at, or near an index location as described above, or at another location. Further, in some embodiments, the magnetic field sensors of the magnetic field sensor array 156 may measure respective magnetic field values at respective different locations proximate the peripheral outer surface 112 (or proximate at least one surface of at least one ferromagnetic object) at a peripheral resolution of about 1 millimeter or less. In other words, in some embodiments, at each of rotational positions that differ by about 1 millimeter or less, the magnetic field sensors of the magnetic field sensor array 156 may measure respective magnetic field values. In some embodiments, each magnetic field sensors of the magnetic field sensor array 156 may measure a plurality (such as three, for example) of measurements at each location, and such measurements at each location may be averaged to produce an average measurement at each location. Further, in some embodiments, the magnetic field sensors of the magnetic field sensor array 156 may automatically measure a plurality of measurements and may internally average the plurality of measurements at each location. Again, the codes at block 250 may direct the microprocessor 208 to identify rotational positions of the sensor device 124, the sensor support body 150, and the magnetic field sensors of the magnetic field sensor array 156, for example from one or more signals that may be received one or more devices, which may include one or more of the motors 130 and 134, one or more of the accelerometers 230 and 232, or one or more other devices.

In some embodiments, the distal ends respective distal ends of the plurality of sensor units 158 may remain in contact with the outer surface 112 (or of at least one surface of at least one ferromagnetic object) as the rotatable support 122 and to the magnetic field sensors of the magnetic field sensor array 156 rotate between different rotational positions as described herein for example. However, in other embodiments, the respective distal ends of the plurality of sensor units 158 may be withdrawn from contact with the outer surface 112 (or at least one surface of at least one ferromagnetic object), moved to a different rotational position, and then returned to contact with the outer surface 112 (or at least one surface of at least one ferromagnetic object).

Also, in some embodiments, while magnetic field values are being measured at block 250, the microprocessors of the sensor modules (such as the microprocessor 184 of the sensor module 180) may process and store data representing measurements of magnetic fields at the magnetic field sensors on the sensor modules, so that data processing and storage may occur in real time as magnetic field values are being measured.

Also, in some embodiments, while magnetic field values are being measured at block 250, the codes at block 250 may also direct the microprocessor 208 to cause the indicator device 228 to indicate (for example by illuminating one or more lights) that magnetic field values are being measured and that inspection is in progress, or to indicate other information about a status of the apparatus 120 or of inspection by the apparatus 120.

The codes at block 250 may also direct the microprocessor 208 to store, in the storage memory 236, representations of magnetic field values measured by the magnetic field sensors of the magnetic field sensor array 156 in association with respective locations of the measured magnetic field values in at least two dimensions of in a co-ordinate system relative to at least one index location. In the embodiment shown, the representations of the measured magnetic field values may be stored in the storage memory 236 in association with respective locations of the measured magnetic field values both in an axial dimension relative to the wheel 100 associated with respective different locations of the magnetic field sensors of the magnetic field sensor array 156 relative to the sensor device 124 or to the sensor support body 150, and in a peripheral or azimuthal direction relative to the wheel 100 associated with respective different rotational positions of the sensor device 124, the sensor support body 150, and the magnetic field sensors of the magnetic field sensor array 156 relative to the wheel 100. However, in alternative embodiments, representations of the measured magnetic field values may be stored in the storage memory 236 in association with respective locations of the measured magnetic field values in two or more other dimensions.

If at block 250 the microprocessor 208 detects an impediment or blockage (for example in response to a signal from one or both of the motors 130 and 134), then the microprocessor 208 may cause an output signal to be produced (for example at a mobile phone, a tablet computer, a personal computer, or another device of the operator) to alert the operator, and the program codes in the program memory 234 may return to block 240. Otherwise, the codes at block 250 may direct the microprocessor 208 to cause the motor drivers 210 and 212 to control the motors 130 and 134 to cause the rotatable support 122 to rotate in one complete rotation around the wheel 100 (or around one or more other ferromagnetic objects), and the codes at block 250 may direct the microprocessor 208 to cause the magnetic field sensors of the magnetic field sensor array 156 to measure respective magnetic field values at respective different locations proximate the peripheral outer surface 112 at different rotational positions in that complete rotation. In some embodiments, such a complete rotation may take between about 5 minutes and about 20 minutes, or up to about 8 minutes, or in less than about 15 minutes, for example.

In some embodiments, the program codes in the program memory 234 may include codes for directing the microprocessor 208 to analyze the representations of measured magnetic field values stored at block 250 in the storage memory 236 to identify locations of any defects (such as corrosion, wear, or other damage or imperfections that may arise over time) in the wheel 100 (or in one or more other ferromagnetic objects). In such embodiments, the indicator device 228 may indicate any detected defects while magnetic field values are being measured at block 250. However, embodiments do not necessarily involve identifying defects or any locations of any defects. In other embodiments, identifying defects may take place on a personal computer or other personal computing device that is in communication microprocessor 208 wirelessly or in a wired configuration via a communications interface (e.g. via wireless communications interface 222 or an equivalent wired communications interface).

The program codes in the program memory 234 may then continue at block 252, which may include codes for directing the microprocessor 208 to cause the motor drivers 210 and 212 to control the motors 130 and 134 to cause the rotatable support 122 to rotate the sensor device 124 back to a position proximate an index location (such as the at least one through-hole 114) and to stop at such a position.

In some embodiments, such as any embodiments that may involve identifying locations of any defects, the program codes in the program memory 234 may continue at block 254, which may include codes for directing the microprocessor 208 to receive a result indication initiation input signal 256 from the operator initiating indexing of the apparatus 120. For example, the operator may use a mobile phone, a tablet computer, a personal computer, or another input device (each a personal computing device) to produce the result indication initiation input signal 256 and to transmit the result indication initiation input signal 256 to the control and processing device 144 (for example to one or more communication interfaces such as the USB interface 214, the Ethernet interface 218, the wireless communications interface 222, or the SPI bus interface 224). The microprocessor 208 may repeatedly execute the codes at block 254 until the result indication initiation input signal 256 is received.

After the result indication initiation input signal 256 is received, the program codes in the program memory 234 may then continue at block 258, which may include codes for directing the microprocessor 208 to indicate a location of a defect in the wheel 100 (or in one or more other ferromagnetic objects). In some embodiments, a location of a defect may be identified by a rotational position of the rotatable support 122 relative to the wheel 100 (or relative to one or more other ferromagnetic objects) and by causing the indicator device 228 to indicate one or more locations along the support body 150. For example, in the embodiment shown, the codes at block 258 may direct the microprocessor 208 to indicate a location of a defect in the wheel 100 (or in one or more other ferromagnetic objects) by causing the motor drivers 210 and 212 to control the motors 130 and 134 to cause the rotatable support 122 to rotate the sensor device 124 to a rotational position indicating the defect, and by causing the indicator device 228 to indicate a location of the defect along the support body 150.

More generally, by rotating the sensor device 124 to a rotational position indicating a defect, and by causing the indicator device 228 to indicate a location of the defect along the support body 150, the apparatus 120 may indicate a location of a defect in at least two dimensions of in a co-ordinate system. In the embodiment shown, the apparatus 120 may indicate a location of a defect in an axial dimension relative to the wheel 100 (indicated by the indicator device 228) and in a peripheral or azimuthal direction relative to the wheel 100 (indicated by a rotational position of the sensor device 124). However, in alternative embodiments, the apparatus 120 may indicate a location of a defect in two or more other dimensions.

When the location of the defect is identified, as described above for example, then the operator may use a marking pen or other marking device to mark the location of the defect on the peripheral outer surface 112 (or on a surface of one or more other ferromagnetic objects). The indicator device 228 may also indicate a type of a defect, for example by indicating a colour or other visually coded indication of the type of the defect.

Further, the codes at block 258 may direct the microprocessor 208 to produce an output signal, which may be encoded information, which may include an identifier of the defect, and which may include an indication of a type, characteristic, and/or severity of the defect, for example. Further, the codes at block 258 may direct the microprocessor 208 to cause one or more communication interfaces (such as the USB interface 214, the Ethernet interface 218, the wireless communications interface 222, or the SPI bus interface 224, for example) to transmit the output signal to a mobile phone, a tablet computer, a personal computer, or another device of the operator and cause the device to display some or all of the encoded information. The operator may then mark some or all of the encoded information (such as the identifier of the defect, and/or the indication of the type, characteristic, and/or severity of the defect, for example) near the location of the defect on the peripheral outer surface 112 (or on a surface of one or more other ferromagnetic objects) using a marking pen or other marking device, for example.

If any locations of any defects have yet to be identified, then the program codes in the program memory 234 may await a further result indication initiation input signal 256, and in response to such a further result indication initiation input signal 256, the codes at block 258 may be repeated until the locations of all defects have been identified. Further, if at block 258 the microprocessor 208 detects an impediment or blockage (for example in response to a signal from one or both of the motors 130 and 134), then the microprocessor 208 may cause an output signal to be produced (for example at a mobile phone, a tablet computer, a personal computer, or another device of the operator) to alert the operator, and the program codes in the program memory 234 may return to block 240.

Otherwise, once all locations of defects have been identified, the program codes in the program memory 234 may continue at block 260, which may include codes for directing the microprocessor 208 to cause the motor drivers 210 and 212 to control the motors 130 and 134 to cause the rotatable support 122 to rotate the sensor device 124 back to a position proximate an index location (such as the at least one through-hole 114) and to stop at such a position.

In some embodiments, at any time, the operator may use a mobile phone, a tablet computer, a personal computer, or another input device to produce an emergency stop input signal 262, which may direct the microprocessor 208 to cause the motor drivers 210 and 212 to stop the motors 130 and 134, and the program codes in the program memory 234 may return to block 240 in response to the emergency stop input signal 262.

After block 260, the program codes in the program memory 234 may cause an output signal to be produced (for example at a mobile phone, a tablet computer, a personal computer, or another device of the operator) to provide the operator with a summary of the inspection and to provide the operator with options for storing or transmitting the representations of measured magnetic field values stored at block 250 in the storage memory 236.

For example, the representations of measured magnetic field values stored at block 250 in the storage memory 236 may be transmitted to and stored by one or more computer devices, for example for archiving, for further analysis (which may include automated analysis and/or analysis by a skilled person), and for reporting. As indicated above, in some embodiments, the program codes in the program memory 234 may include codes for directing the microprocessor 208 to analyze the representations of measured magnetic field values stored at block 250 in the storage memory 236. More generally, in some embodiments, the representations of measured magnetic field values stored at block 250 in the storage memory 236 may be analyzed to identify defects in one or more ferromagnetic objects. As indicated earlier, in various embodiments the following analysis may be performed on a personal computer or other personal computing device.

First, in some embodiments, representations of measured magnetic field values may be filtered, for example to minimize or to reduce background noise and/or error codes. Additionally or alternatively, averaging a plurality of measurements at each location may also minimize or reduce background noise and/or error codes. An example of a form of filter that may be applied is a digital Chebyshev filter known in the art. In some embodiments, with any such filtering program codes may be include to allow a user to select the cutoff frequency and number of poles along with the number of times the data will be filtered (along the x-axis may mean the data from the same sensor in time; along the y-axis may mean all of the sensors at the same time).

Further, in some embodiments, analysis of the measured magnetic field values may also involve adjusting the measured magnetic field values to exclude an ambient magnetic field such as the ambient magnetic field of the Earth. The ambient magnetic field of the Earth may effectively be static over the time period when magnetic field values may be measured as described herein for example, so the ambient magnetic field of the Earth may be ascertained and subtracted from the measured magnetic field values.

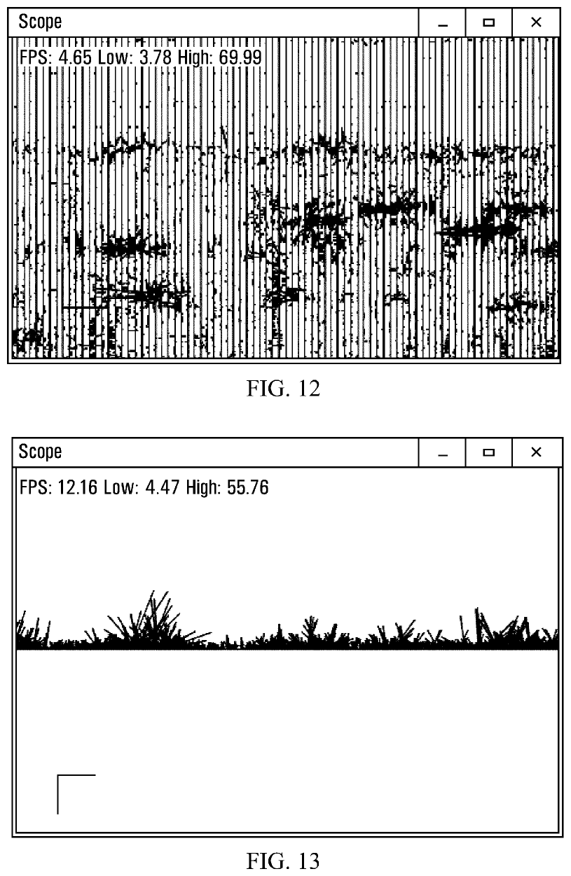

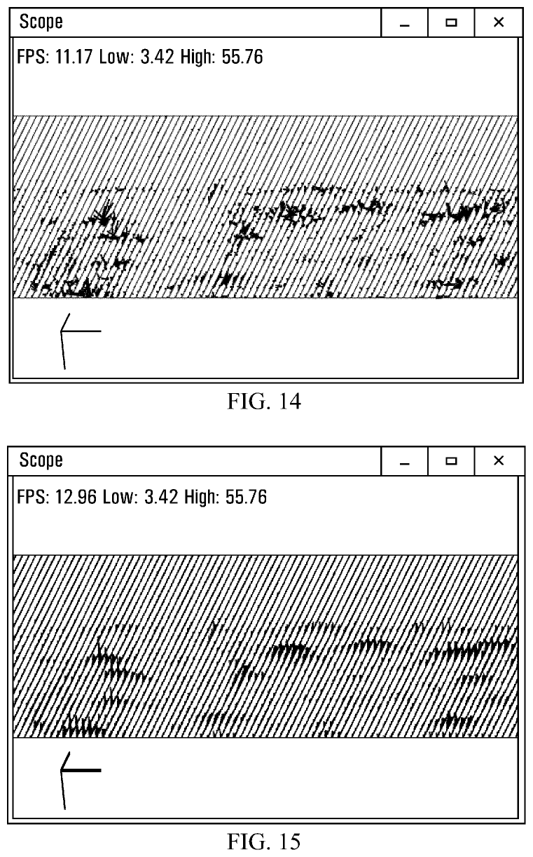

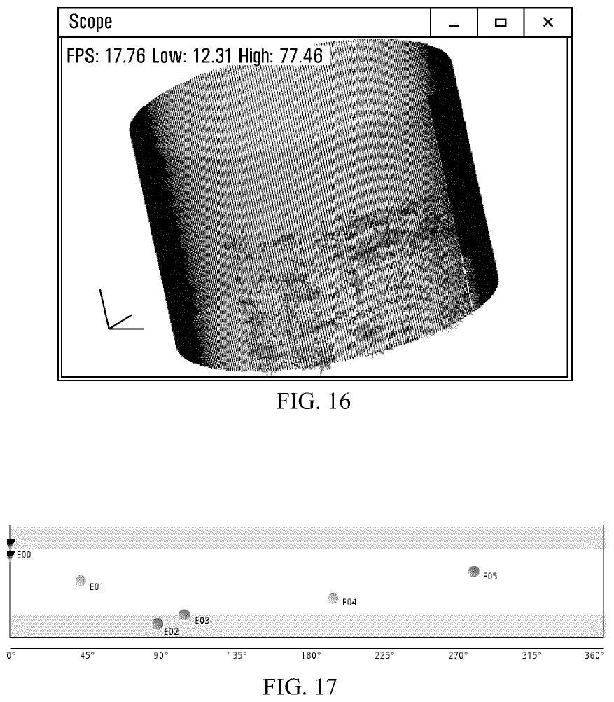

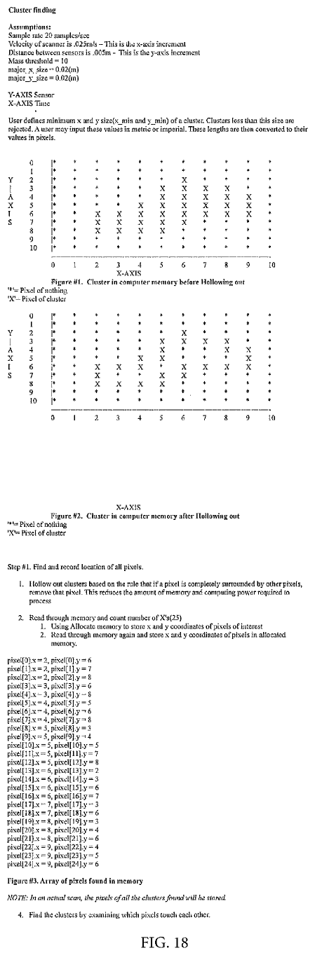

Further, in some embodiments, measured magnetic field values may be converted to vectors, for example by calculating a change from a measured magnetic field value at one location to a measured magnetic field value at an adjacent or nearby location. Such vectors may represent fluctuations in magnetic field proximate at least one surface of one or more ferromagnetic objects being inspected. For example, FIG. 12 illustrates both magnitude and direction of such vectors as calculated from magnetic field values measured at locations proximate a portion of a peripheral surface of a ferromagnetic wheel for an OTR vehicle such as the wheel 100 using an apparatus such as the apparatus 120. The vectors in FIG. 12 are projected on a plane. FIG. 13 is a side view of the vectors of FIG. 12, illustrating both magnitude and direction of the vectors. FIG. 14 is a perspective view of the vectors of FIG. 12, illustrating both magnitude and direction of the vectors. FIG. 15 is a perspective view of the vectors of FIG. 12, illustrating only magnitude of the vectors. FIG. 16 is a perspective view of the vectors of FIG. 12, illustrating both magnitude and direction of the vectors with the vectors projected on a cylinder.

Embodiments such as those described herein may measure magnetic fields with sufficient resolution for three-dimensional magnetic flux feature extraction, which may indicate defects or anomalies. As indicated above, some embodiments may involve identifying locations of any defects, and in such embodiments, the magnetic field values measured proximate a surface of one or more ferromagnetic objects, or vectors such as those described above for example, may be filtered and/or cross-correlated to identify patterns that may reflect defects (such as corrosion, wear, or other damage or imperfections that may arise over time) or other anomalies, and locations, types, characteristics, and/or severities of defects or other anomalies in the one or more ferromagnetic objects. In some embodiments, identification of such patterns may be similar to magnetic image processing techniques used in magnetic resonance imaging (“MRI”). Some embodiments may, for example, use pattern criteria to automate identification of defects in one or more ferromagnetic objects.

For example, in the absence of any defects or other anomalies (such as the at least one through-hole 114), measured magnetic field values may be relatively uniform or may have relatively uniform variations in amplitude and/or in polarity. However, as one example, the at least one through-hole 114 may cause a symmetrically curved surface fringing dipole that may be easily discerned. As another example, a crack or fissure may cause leakage flux that can may also be easily discerned. As another example, surface cracks and/or fatigue may cause localized changes in permeability and may cause irregularly shaped fringing dipoles and/or surface dipoles that can may also be easily discerned. As another example, sub-surface inclusions or voids may cause a change in reluctance to an entry or to an exit of magnetic flux, which may be elliptical in shape, and may appear as localized changes in permeability. A shallow void may produce some minor surface fringe effects, whereas a deeper void may not. As another example, a loss of material may cause such a change in reluctance but having a different shape or pattern. As another example, holes, weldments, or material buildup may cause localized changes in permeability and flux fringing. As another example, metallurgical differences in ferromagnetic materials, material variations, or occlusions may cause ferromagnetic reluctance changes that may be apparent as changes in permeability over a large area. For example, welds may be apparent due to their changed metallurgy and profile. In general, non-uniform patterns of vectors such as those described herein, such as clusters and knots of ends of such vectors that trend towards a common center point, for example, may indicate defects or other abnormalities.

Once any defects are identified, an output report may be generated. In general, such an output report may include identifications of defects and identifiers, locations, types, characteristics, and/or severities of any such defects, and such reports may include other information such as an identification of the at least one ferromagnetic object may be inspected.

For example, one or more ferromagnetic objects may be identified by radio-frequency identification (“RFID”) or by a serial number that may be entered automatically or manually into the apparatus 120 and that may be included in a report. Such reports may include other information such as an identifier of the operator and/or a time and date of the inspection, for example. For example, FIG. 17 illustrates an example of an output report and illustrates an index position E00 depicted using two triangles, which are locations of through-holes for receiving respective air valve stems, such as the at least one through-hole 114 for example. Also, in the example of FIGS. 17, E01 and E04 indicate cracks, and E02, E03, and E05 indicate voids. A report may be analyzed by a computer and/or by skilled person, and may include a recommendation generated by the computer or by the skilled person. Such a recommendation may indicate that the at least one ferromagnetic object be used, repaired, or scrapped, for example.

Embodiments such as those described herein may permit inspection of large ferromagnetic objects and may avoid additional expense or delay that may be required for alternatives such as known NDT testing, for example. For example, embodiments including 15 modules such as those described herein may measure magnetic fields values along a linear dimension of about 1.5 meters. More generally, embodiments such as those described herein may be operated by a single operator, who may not necessarily be a skilled NDT technician, and embodiments such as those described herein may inspect at least one ferromagnetic object with sufficient resolution and may have magnetic field sensors with sufficient sensitivity and positioned sufficiently close to at least one surface of the at least one ferromagnetic object to measure magnetic fields values proximate at least one surface of at least one ferromagnetic object with information that may, for example, be used to detect defects in the at least one ferromagnetic object without requiring washing, paint removal, repainting, involvement of skilled NDT technicians, or transportation to a location where NDT is available, for example. Embodiments such as those described herein may, in some examples, inspect over 95% of at least one ferromagnetic object such as a wheel for an OTR vehicle, for example, between about 5 minutes and about 20 minutes, or up to about 8 minutes, or in less than about 15 minutes, for example.

In various embodiments, identification of defects through computerized analysis of the data collected may be performed using a cluster finding technique or routine. An illustrative example is described below. A cluster is a series of data points that touch each other. Clusters may come in all shapes and sizes. All of data points may be sorted into a third array structure that records all of their x and y coordinates. A computer program removes the first data points x and y coordinate from the array. It then calculates the eight other points around it and searches the third array for any points that match. Found points are removed from the third array and added to the clusters array. This is done for all of the points found until none are left. The program now has a cluster of points. Examining these points yields data such as the mass of the cluster (number of points), maximum size along the x and y axis in addition to its location on the rim. To further speed up and simplify the operation, only the outline of the cluster may be needed.

Before a cluster is stored in memory one may filter out unlikely candidates. The simplest filtering option is to omit clusters that have less than a certain “mass” as represented by data. This value can be user defined. At this point, performing some classification based on the shape of the cluster can be done. For example, using a Hough line transform and a Hough circle transform will allow the software to find if the cluster conforms to a line or a circle. Other techniques such as machine learning or curve fitting may also be used. Once all clusters of interest are recorded and classified a report can be generated.

The following provides further illustration of cluster finding in operation for various embodiments.

Assumptions:
Sample rate 20 samples/sec
Velocity of scanner is 0.025 m/s—This is the x-axis increment
Distance between sensors is 0.005 m—This is the y-axis increment
Mass threshold=10
major_x_size=0.02 (m)
major_y_size=0.02 (m)
Y-AXIS Sensor
X-AXIS Time

User defines minimum x and y size (x_min and y_min) of a cluster. Clusters less than this user-definable size are rejected. A user may input these values in metric or imperial in various embodiments. These lengths are then converted to their values in pixels.

TABLE 1
Cluster in computer memory before Hollowing out

```
  0 |* * * * * * * * * * *
  1 |* * * * * * * * * * *
Y 2 |* * * * * * X * * * *
| 3 |* * * * * X X X X * *
A 4 |* * * * * X X X X X *
X 5 |* * * * X X X X X X *
I 6 |* * X X X X X X X X *
S 7 |* * X X X X X * * * *
  8 |* * X X X X * * * * *
  9 |* * * * * * * * * * *
10 |* * * * * * * * * * *
------------------------------
    0 1 2 3 4 5 6 7 8 9 10
```

X-AXIS

‘*’ = Pixel of nothing
‘X’ = Pixel of cluster

TABLE 2
Cluster in computer memory after Hollowing out

```
  0 |* * * * * * * * * * *
  1 |* * * * * * * * * * *
Y 2 |* * * * * * X * * * *
| 3 |* * * * * X X X X * *
A 4 |* * * * * X * * X X *
X 5 |* * * * X X * * * X *
I 6 |* * X X X * X X X X *
S 7 |* * X * * X X * * * *
  8 |* * X X X X * * * * *
  9 |* * * * * * * * * * *
10 |* * * * * * * * * * *
------------------------------
    0 1 2 3 4 5 6 7 8 9 10
```

X-AXIS

‘*’ = Pixel of nothing
‘X’ = Pixel of cluster

Step: Find and record location of all pixels.

1. Hollow out clusters based on the rule that if a pixel is completely surrounded by other pixels, remove that pixel. This reduces the amount of memory and computing power required to process

2. Read through memory and count number of X's

a. Using Allocate memory to store x and y coordinates of pixels of interest

b. Read through memory again and store x and y coordinates of pixels in allocated memory.

TABLE 3
Sample array of pixels found in memory

pixel[0].x = 2, pixel[0].y = 6
pixel[1].x = 2, pixel[1].y = 7
pixel[2].x = 2, pixel[2].y = 8
pixel[3].x = 3, pixel[3].y = 6
pixel[4].x = 3, pixel[4].y = 8
pixel[5].x = 4, pixel[5].y = 5
pixel[6].x = 4, pixel[6].y = 6
pixel[7].x = 4, pixel[7].y = 8
pixel[8].x = 5, pixel[8].y = 3
pixel[9].x = 5, pixel[9].y = 4
pixel[10].x = 5, pixel[10].y = 5
pixel[11].x = 5, pixel[11].y = 7
pixel[12].x = 5, pixel[12].y = 8
pixel[13].x = 6, pixel[13].y = 2
pixel[14].x = 6, pixel[14].y = 3
pixel[15].x = 6, pixel[15].y = 6
pixel[16].x = 6, pixel[16].y = 7
pixel[17].x = 7, pixel[17].y = 3
pixel[18].x = 7, pixel[18].y = 6
pixel[19].x = 8, pixel[19].y = 3
pixel[20].x = 8, pixel[20].y = 4
pixel[21].x = 8, pixel[21].y = 6
pixel[22].x = 9, pixel[22].y = 4
pixel[23].x = 9, pixel[23].y = 5
pixel[24].x = 9, pixel[24].y = 6

Find the clusters by examining which pixels touch each other.

1. Create second array for found pixels.

2. Take a pixel from the array and place into second array. This is the initial pixel. Remove initial pixel from first array by setting it to 0. Calculate eight coordinates around the initial pixel. Search the first array for the eight coordinates. Add coordinates that match to the second array and remove found pixels from first array. Go through second array and calculate pixels around found pixels and search first array for matches. Do this until no more matches. The second array now contains all of the pixels that make up the cluster.

Examine pixels in the second array and find the minimum and maximum values of x and y coordinates and record. Count the number of pixels in the second array.

Characteristics of the cluster can be calculated and recorded.

In various embodiments the following parameters may apply:

Sample rate 20 samples/sec

Velocity of scanner is 0.025 m/sec—This is the x-axis increment

0.25 m/sec divided by 20 samples/sec=0.25 m/sec*1/20 sec/sample=

0.0125 m/sample(pixel)

Distance between sensors is 0.005 m—This is the y-axis increment

delta_x=9−2=7*0.0125 m/sample(pixel)=0.0875 m

delta_y=9−2=7*0.005 m/pixel=0.035 m

Center of cluster on x-axis=(9+2)/2=5.5

Center of cluster on y-axis=(9+2)/2=5.5

Mass threshold=10

Table #4. Sample text string of cluster found. (′<′=start token ‘>’=end token)

<x_max=9 x_min=2 y_max=9 y_min=2 mass=25 dx=7 dy=7 dmx=0.0875 dmy=0.035 xc=5.5 yc=5.5 type=major shape=unknown>

A file can be created and the clusters found stored there. Before the text strings are written to file, filtering based on any of the fields found in the string can be done. For example, a lower limit on the mass of the cluster can be made excluding clusters with a mass less than 10 (Mass threshold).

At this point depending on the requirement, we may have enough data and processing could stop after all valid clusters are found. In the report, each cluster is noted and the user will determine whether the clusters are valid or not. Using the values of major_x_size and major_y_size as filters, if dmx and dmy are greater than major_x_size and major_y_size it is classified as a major cluster. If less than it is classified as a minor cluster.

Pattern Recognition.

If additional pattern discernment is required, a simple Hough line transform and Hough circle transform may be used in various embodiments. The shape field can then filled in as required. Please see web pages below for algorithmic implementation: (a) https://en.wikipedia.org/wiki/Hough_transform; and (b) https://en.wikipedia.org/wiki/Circle_Hough_Transform.

Although specific embodiments have been described and illustrated, such embodiments should be considered illustrative only and not as limiting the invention as construed according to the accompanying claims.

1. A method of inspecting a ferromagnetic object, the method comprising:
positioning a plurality of magnetic field sensors proximate the ferromagnetic object; and
when a plurality of magnetic field sensors sense respective magnetic field values at respective different locations proximate at least one surface of the ferromagnetic object, causing the plurality of magnetic field sensors to generally traverse around the ferromagnetic object.

2. The method of claim 1 wherein causing the plurality of magnetic field sensors to generally traverse around the ferromagnetic object comprises causing a plurality of magnetic field sensor units, each comprising at least one of the plurality of magnetic field sensors, to rotate around the ferromagnetic object.

3. The method of claim 2 wherein the plurality of magnetic field sensor units are independently movable non-tangentially relative to the ferromagnetic object as the plurality of magnetic field sensors rotate around the ferromagnetic object.

4. The method of claim 2 wherein the plurality of magnetic field sensor units are independently movable generally radially relative to the ferromagnetic object as the plurality of magnetic field sensors rotate around the ferromagnetic object.

5. The method of claim 2, 3, or 4 wherein each of the plurality of magnetic field sensor units comprises two of the plurality of magnetic field sensors.

6. The method of any one of claims 1 to 5 wherein the plurality of magnetic field sensors are generally coplanar.

7. The method of any one of claims 1 to 6 wherein the plurality of magnetic field sensors are in respective different positions generally along an axial direction relative to the ferromagnetic object.

8. The method of any one of claims 1 to 6 wherein the plurality of magnetic field sensors are in respective different positions generally along a generally vertical line.

9. The method of any one of claims 1 to 8 wherein the plurality of magnetic field sensors are in respective different positions generally along a line with a linear density of about 200 of the plurality of magnetic field sensors per meter.

10. The method of any one of claims 1 to 8 wherein the plurality of magnetic field sensors are in respective different positions generally along a line with a linear density of at least 200 of the plurality of magnetic field sensors per meter.

11. The method of any one of claims 1 to 10 wherein the plurality of magnetic field sensors comprises a plurality of magnetic tunnel junction magnetic field sensors.

12. The method of any one of claims 1 to 11 wherein the plurality of magnetic field sensors comprises a plurality of three-dimensional magnetic field sensors.

13. The method of any one of claims 1 to 12 wherein causing the plurality of magnetic field sensors to rotate around the ferromagnetic object comprises causing the plurality of magnetic field sensors to rotate around an axis of rotation of the ferromagnetic object.

14. The method of any one of claims 1 to 13 wherein causing the plurality of magnetic field sensors to rotate around the ferromagnetic object comprises causing the plurality of magnetic field sensors to rotate around an axis of symmetry of the ferromagnetic object.

15. The method of any one of claims 1 to 14 wherein the ferromagnetic object is a wheel.

16. The method of any one of claims 1 to 14 wherein the ferromagnetic object is a wheel of an off-the-road (“OTR”) vehicle.

17. The method of any one of claims 1 to 16 wherein the at least one surface of the ferromagnetic object comprises at least one peripheral outer surface of the ferromagnetic object.

18. The method of any one of claims 1 to 17 further comprising causing at least one computer-readable medium to store representations of magnetic fields measured by the plurality of magnetic field sensors at a plurality of different rotational positions around the ferromagnetic object.

19. The method of any one of claims 1 to 18 wherein causing the plurality of magnetic field sensors to rotate around the ferromagnetic object comprises causing at least one processor to control rotation of the plurality of magnetic field sensors around the ferromagnetic object.

20. The method of any one of claims 1 to 19 wherein causing the plurality of magnetic field sensors to rotate around the ferromagnetic object comprises causing the plurality of magnetic field sensors to rotate around the ferromagnetic object and between about 0.5 millimeters and about 1 millimeter from the at least one surface of the ferromagnetic object.

21. The method of any one of claims 1 to 19 wherein causing the plurality of magnetic field sensors to rotate around the ferromagnetic object comprises causing the plurality of magnetic field sensors to rotate around the ferromagnetic object and less than about 1 millimeter from the at least one surface of the ferromagnetic object.

22. An apparatus for inspecting a ferromagnetic object, the apparatus comprising:
a measuring means for measuring a plurality of magnetic field values at respective different locations proximate at least one surface of the ferromagnetic object; and
a rotating means for rotating the measuring means and the respective different sensing locations around the ferromagnetic object.

23. An apparatus for inspecting a ferromagnetic object, the apparatus comprising:
a rotatable support supportable on the ferromagnetic object and rotatable relative to the ferromagnetic object when supported on the ferromagnetic object; and
a plurality of magnetic field sensors supportable by the rotatable support;
wherein when the rotatable support is supported on the ferromagnetic object and when the plurality of magnetic field sensors are supported by the rotatable support:
the plurality of magnetic field sensors are positioned to measure respective magnetic field values at respective different locations proximate at least one surface of the ferromagnetic object; and
the plurality of magnetic field sensors and the respective different locations are rotatable around the ferromagnetic object in response to rotation of the rotatable support relative to the ferromagnetic object.

24. The apparatus of claim 23 further comprising a plurality of magnetic field sensor units, each comprising at least one of the plurality of magnetic field sensors.

25. The apparatus of claim 24 wherein the plurality of magnetic field sensor units are independently movable non-tangentially relative to the ferromagnetic object when the rotatable support is supported on the ferromagnetic object and when the plurality of magnetic field sensors are supported by the rotatable support.

26. The apparatus of claim 24 wherein the plurality of magnetic field sensor units are independently movable generally radially relative to the ferromagnetic object when the rotatable support is supported on the ferromagnetic object and when the plurality of magnetic field sensors are supported by the rotatable support.

27. The apparatus of claim 24, 25, or 26 wherein each one of the plurality of magnetic field sensor units comprises two of the plurality of magnetic field sensors.

28. The apparatus of any one of claims 23 to 27 wherein the plurality of magnetic field sensors are generally coplanar.

29. The apparatus of any one of claims 23 to 28 wherein the plurality of magnetic field sensors are in respective different positions generally along an axial direction relative to the ferromagnetic object.

30. The apparatus of any one of claims 23 to 28 wherein the plurality of magnetic field sensors are in respective different positions generally along a generally vertical line.

31. The apparatus of any one of claims 23 to 30 wherein the plurality of magnetic field sensors are in respective different positions generally along a line with a linear density of about 200 of the plurality of magnetic field sensors per meter.

32. The apparatus of any one of claims 23 to 30 wherein the plurality of magnetic field sensors are in respective different positions generally along a line with a linear density of at least 200 of the plurality of magnetic field sensors per meter.

33. The apparatus of any one of claims 23 to 32 wherein the plurality of magnetic field sensors comprises a plurality of magnetic tunnel junction magnetic field sensors.

34. The apparatus of any one of claims 23 to 33 wherein the plurality of magnetic field sensors comprises a plurality of three-dimensional magnetic field sensors.

35. The apparatus of any one of claims 23 to 34 wherein when the rotatable support is supported on the ferromagnetic object and when the plurality of magnetic field sensors are supported by the rotatable support, the plurality of magnetic field sensors and the respective different locations are rotatable around an axis of rotation of the ferromagnetic object in response to rotation of the rotatable support relative to the ferromagnetic object.

36. The apparatus of any one of claims 23 to 35 wherein when the rotatable support is supported on the ferromagnetic object and when the plurality of magnetic field sensors are supported by the rotatable support, the plurality of magnetic field sensors and the respective different locations are rotatable around an axis of symmetry of the ferromagnetic object in response to rotation of the rotatable support relative to the ferromagnetic object.

37. The apparatus of any one of claims 23 to 36 wherein the at least one surface of the ferromagnetic object comprises at least one peripheral outer surface of the ferromagnetic object.

38. The apparatus of any one of claims 23 to 37 further comprising:
at least one processor in communication with the plurality of magnetic field sensors; and
at least one computer-readable medium in communication with the at least one processor and comprising codes stored thereon that, when executed by the at least one processor, cause the at least one processor to store, on the at least one computer-readable medium, respective representations of magnetic fields measured by the plurality of magnetic field sensors at different rotational positions of the plurality of magnetic field sensors relative to the ferromagnetic object.

39. The apparatus of any one of claims 23 to 37 further comprising at least one actuator that, when actuated, causes the rotatable support to rotate relative to the ferromagnetic object when the rotatable support is supported on the ferromagnetic object.

40. The apparatus of claim 39 further comprising:
at least one processor in communication with the at least one actuator; and
at least one computer-readable medium in communication with the at least one processor and comprising codes stored thereon that, when executed by the at least one processor, cause the at least one processor to control the at least one actuator to control rotation of the rotatable support relative to the ferromagnetic object.

41. The apparatus of any one of claims 23 to 40 wherein when the rotatable support is supported on the ferromagnetic object and when the plurality of magnetic field sensors are supported by the rotatable support, the plurality of magnetic field sensors are positionable between about 0.5 millimeters and about 1 millimeter from the at least one surface of the ferromagnetic object.

42. The apparatus of any one of claims 23 to 40 when the rotatable support is supported on the ferromagnetic object and when the plurality of magnetic field sensors are supported by the rotatable support, the plurality of magnetic field sensors are positionable less than about 1 millimeter from the at least one surface of the ferromagnetic object.

43. Use of the apparatus of any one of claims 22 to 42 to inspect the ferromagnetic object.

44. The use of claim 43 wherein the ferromagnetic object is a wheel.

45. The use of claim 43 wherein the ferromagnetic object is a wheel of an OTR vehicle.
